(19) United States
(12) Patent Application Publication
(10) Pub. No.: US 2016/0160890 A1
(43) Pub. Date: Jun. 9, 2016

(54) SYSTEMS AND METHODS FOR ROTOR AXIAL FORCE BALANCING

(71) Applicant: Energy Recovery, Inc., San Leandro, CA (US)

(72) Inventor: David Deloyd Anderson, Castro Valley, CA (US)

(21) Appl. No.: 14/958,697

(22) Filed: Dec. 3, 2015

Related U.S. Application Data
(60) Provisional application No. 62/088,436, filed on Dec. 5, 2014.

(51) Int. Cl. F15B 15/06

(52) U.S. Cl. CPC F15B 15/063

(57) ABSTRACT

A system includes a rotary isobaric pressure exchanger (IPX) configured to exchange pressures between a first fluid and a second fluid. The rotary IPX includes a sleeve, a rotor disposed within the sleeve in a concentric arrangement, a first endplate disposed proximate to a first axial face of the rotor, a second endplate disposed proximate to a second axial face of the rotor, and a plenum. The plenum includes a radial gap between an outer lateral surface of the rotor and an inner surface of the sleeve, a first axial gap between the first axial face of the rotor and the first endplate, and a second axial gap between the second axial face of the rotor and the second endplate. The plenum is asymmetric about an axial midplane of the rotor. The system also includes a hydrostatic bearing system configured to route a bearing fluid to the plenum.

### CROSS-REFERENCE TO RELATED APPLICATION

This application claims priority to and the benefit of U.S. Provisional Application No. 62/088,436, entitled “SYSTEMS AND METHODS FOR ROTOR AXIAL FORCE BALANCING,” filed Dec. 5, 2014, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to rotating equipment, and, more particularly, to systems and methods for an axial bearing system for use with rotating equipment.

Fluid handling equipment, such as rotary pumps, pressure exchangers, and hydraulic energy transfer systems, may be susceptible to loss in efficiency, loss in performance, wear, and sometimes breakage over time. As a result, the equipment must be taken off line for inspection, repair, and/or replacement. Unfortunately, the downtime of this equipment may be labor intensive and costly for the particular plant, facility, or work site. In certain instances, the fluid handling equipment may be susceptible to misalignment, imbalances, or other irregularities, which may increase wear and other problems, and also cause unexpected downtime. This equipment downtime is particularly problematic for continuous operations. Therefore, a need exists to increase the reliability and longevity of fluid handling equipment.

In certain applications, axial pressure imbalances (e.g., the difference in average pressure between two axial faces) may exert a substantial net force on rotating components of the fluid handling equipment. Axial forces may also arise due to the weight of the rotating components. In some situations, imbalanced pressure loading on the rotating components may cause the rotating components to axially translate, which may result in axial contact between the rotating components and stationary components of the fluid handling equipment. Unfortunately, such axial contact may result in stalling of the fluid handling equipment and wear and/or stress on the fluid handling equipment, and may reduce the life of the fluid handling equipment and result in a loss of efficiency.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic diagram of a hydraulic fracturing system with a hydraulic energy transfer system;

FIG. 2 is an exploded perspective view of an embodiment of the hydraulic energy transfer system of FIG. 1, illustrated as a rotary isobaric pressure exchanger (IPX) system;

FIG. 3 is an exploded perspective view of an embodiment of a rotary IPX in a first operating position;

FIG. 4 is an exploded perspective view of an embodiment of a rotary IPX in a second operating position;

FIG. 5 is an exploded perspective view of an embodiment of a rotary IPX in a third operating position;

FIG. 6 is an exploded perspective view of an embodiment of a rotary IPX in a fourth operating position;

FIG. 7 is a cross-sectional view of an embodiment of the hydraulic energy transfer system of FIG. 1, illustrating the hydraulic energy transfer system with a hydrostatic bearing system;

FIG. 8 is a cross-sectional axial view taken along line 8-8 of FIG. 7, illustrating an embodiment of an endplate of the hydraulic energy transfer system of FIG. 7;

FIG. 9 is a schematic diagram of an embodiment of the hydraulic energy transfer system, illustrating an axial translation of a rotor of the hydraulic energy transfer system;

FIG. 10 is a schematic diagram of an embodiment of the hydraulic energy transfer system having a hydrostatic bearing system, illustrating a plenum region of the hydrostatic bearing system that is asymmetric about an axial midplane of a rotor of the hydraulic energy transfer system with respect to axial extent of the rotor diameter reduction steps; and

FIG. 11 is a schematic diagram of an embodiment of the hydraulic energy transfer system having a hydrostatic bearing system, illustrating a plenum region of the hydrostatic bearing system that is asymmetric about an axial midplane of a rotor of the hydraulic energy transfer system with respect to the rotor diameters within the steps.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Well completion operations in the oil and gas industry often involve hydraulic fracturing (often referred to as fracking or fracing) to increase the release of oil and gas in rock formations. Hydraulic fracturing involves pumping a fluid (e.g., frac fluid) containing a combination of water, chemicals, and proppant (e.g., sand, ceramics) into a well at high-pressures. The high-pressures of the fluid increases crack size and propagation through the rock formation releasing more oil and gas, while the proppant prevents the cracks from closing once the fluid is depressurized. Fracturing operations use a variety of rotating equipment, such as a hydraulic energy transfer system, to handle a variety of fluids.

As discussed in detail below, the embodiments disclosed herein generally relate to systems and methods for rotating systems that may be utilized in various industrial applications. For example, the embodiments disclosed herein may generally relate to rotating systems utilized within a hydraulic fracturing system. As noted above, hydraulic fracturing systems and operations use a variety of rotating equipment, such as a hydraulic energy transfer system, to handle a variety of fluids. In certain situations, the hydraulic energy transfer system may include a bearing system, such as a hydrostatic bearing system, to facilitate the rotation of the rotating components of the hydraulic energy transfer system by providing a bearing fluid (e.g., a lubricating fluid such as oil, grease, and/or liquid/powder mixtures with powder, graphite, PTFE, molybdenum disulfide, tungsten disulfide, etc.). In particular, the bearing fluid may be routed through an outer surface of a sleeve of the hydraulic energy transfer system and into an inner surface of the sleeve of the hydraulic energy transfer system via a pressure differential or a pressure gradient. For example, the bearing fluid may be provided at a high-pressure from the outer surface of the sleeve and the bearing fluid may travel through an aperture (e.g., a bearing inlet) through the sleeve into a radial bearing region (e.g., a radial plenum) of the hydraulic energy transfer system. The radial bearing region may be disposed between the inner surface of the sleeve and the outer surface (e.g., outer lateral surface) of a rotor of the hydraulic energy transfer system. In addition, the bearing fluid may move through the radial bearing region to a lower pressure region via the pressure gradients present in the hydraulic energy transfer system. In particular, the bearing system may be specifically designed with and/or may include a pressure differential system (or lubricant suction-driven flow system) to induce flow of the bearing fluid along the various bearing surfaces. The bearing system also may be designed to provide a constant or differential flow and distribution of the bearing fluid, depending on areas of high or low wear.

However, in certain situations involving high pressures or other challenging applications, axial force imbalances (e.g., the difference in average pressure between two axial faces) may exert a substantial axial net force on rotating components of the hydraulic energy transfer system. Axial force imbalances may also arise due to the weight of the rotating components. In some situations, unbalanced loading on the rotating components may cause the rotating components to axially translate, which may result in axial contact between the rotating components and stationary components of the hydraulic energy transfer system. Unfortunately, such axial contact may result in stalling of the hydraulic energy transfer system (e.g., the rotor may stop spinning) and wear and/or stress on the hydraulic energy transfer system, and may reduce the life of the hydraulic energy transfer system and result in a loss of efficiency. Accordingly, the embodiments described herein provide systems and methods for a bearing system that includes features to compensate for, correct, and/or offset net axial forces on the rotating components of the hydraulic energy transfer system, which may reduce, resist, or avoid axial translation of the rotor. Additionally, the disclosed bearing system includes features that provide increased load bearing capacity and/or increased bearing stiffness (e.g., a bearing system with a higher bearing stiffness may have a clearance that changes less under load as compared to a bearing system with a lower bearing stiffness) to facilitate the rotation of the rotating components.

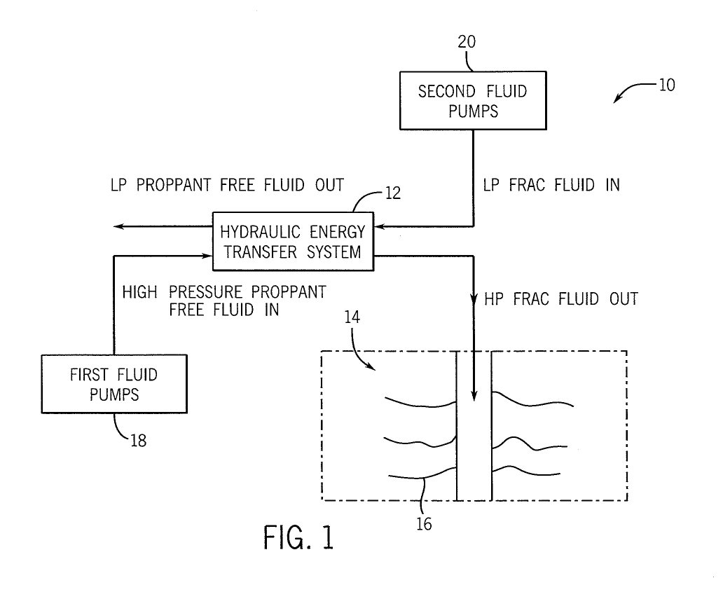

With the foregoing in mind, FIG. 1 is a schematic diagram of an embodiment of a hydraulic fracturing system 10 (e.g., fluid handling system, hydraulic protection system, hydraulic buffer system, or hydraulic isolation system) with a hydraulic energy transfer system 12. The hydraulic fracturing system 10 enables well completion operations to increase the release of oil and gas in rock formations. Specifically, the hydraulic fracturing system 10 pumps a proppant containing fluid (e.g., a frac fluid) containing a combination of water, chemicals, and proppant (e.g., sand, ceramics, etc.) into a well 14 at high pressures. The high pressures of the proppant containing fluid increases the size and propagation of cracks 16 through the rock formation, which releases more oil and gas, while the proppant prevents the cracks 16 from closing once the proppant containing fluid is depressurized. As illustrated, the hydraulic fracturing system 10 may include one or more first fluid pumps 18 and one or more second fluid pumps 20 coupled to the hydraulic energy transfer system 12. For example, the hydraulic energy transfer system 12 may include a hydraulic turbocharger, rotary isobaric pressure exchanger (IPX), reciprocating IPX, or any combination thereof. In addition, the hydraulic energy transfer system 12 may be disposed on a skid separate from the other components of the hydraulic fracturing system 10, which may be desirable in situations in which the hydraulic energy transfer system 12 is added to an existing hydraulic fracturing system 10.

In operation, the hydraulic energy transfer system 12 transfers pressures without any substantial mixing between a first fluid (e.g., proppant free fluid) pumped by the first fluid pumps 18 and a second fluid (e.g., proppant containing fluid or frac fluid) pumped by the second fluid pumps 20. In this manner, the hydraulic energy transfer system 12 blocks or limits wear on the first fluid pumps 18 (e.g., high-pressure pumps), while enabling the hydraulic fracturing system 10 to pump a high-pressure frac fluid into the well 14 to release oil and gas. In addition, because the hydraulic energy transfer system 12 is configured to be exposed to the first and second fluids, the hydraulic energy transfer system 12 may be made from materials resistant to corrosive and abrasive substances in either the first and second fluids. For example, the hydraulic energy transfer system 12 may be made out of ceramics (e.g., alumina, cermets, such as carbide, oxide, nitride, or boride hard phases) within a metal matrix (e.g., Co, Cr, Ni, or any combination thereof). In certain embodiments, the hydraulic energy transfer system 12 may be made out of tungsten carbide in a matrix of CoCr, Ni, NiCr, or Co.

While the illustrated embodiment relates to a hydraulic fracturing system 10 as one example application, the hydraulic energy transfer system 12 may be used with any suitable fluid handling system configured to utilize a high pressure fluid. For example, the hydraulic energy transfer system 12 may be used with desalination systems, urea production systems, ammonium nitrate production systems, urea ammonium nitrate (UAN) production systems, polyamide production systems, polyurethane production systems, phosphoric acid production systems, phosphate fertilizer production systems, calcium phosphate fertilizer production systems, oil refining systems, oil extraction systems, petrochemical systems, pharmaceutical systems, or any other systems configured to handle abrasive and/or corrosive fluids. Further, the first fluid may be a pressure exchange fluid or a clean fluid that is non-abrasive, non-corrosive, and/or substantially particulate free (e.g., proppant-free). For example, the first fluid may be water or a dielectric fluid (e.g., oil). In certain embodiments, the second fluid may be a fluid that is abrasive, corrosive, and/or particulate-laden (e.g., proppant-laden, a frac fluid). The first and second fluids may be multi-phase fluids such as gas/liquid flows, gas/solid particulate flows, liquid/solid particulate flows, gas/liquid/solid particulate flows, or any other multi-phase flow. For example, the multi-phase fluids may include sand, solid particles, powders, debris, ceramics, or any combination therefore. These fluids may also be non-Newtonian fluids (e.g., shear thinning fluid), highly viscous fluids, non-Newtonian fluids containing proppant, or highly viscous fluids containing proppant. Further, the first fluid may be at a first pressure between approximately 5,000 kPa to 25,000 kPa, 20,000 kPa to 50,000 kPa, 40,000 kPa to 75,000 kPa, 75,000 kPa to 100,000 kPa or greater than a second pressure of the second fluid.

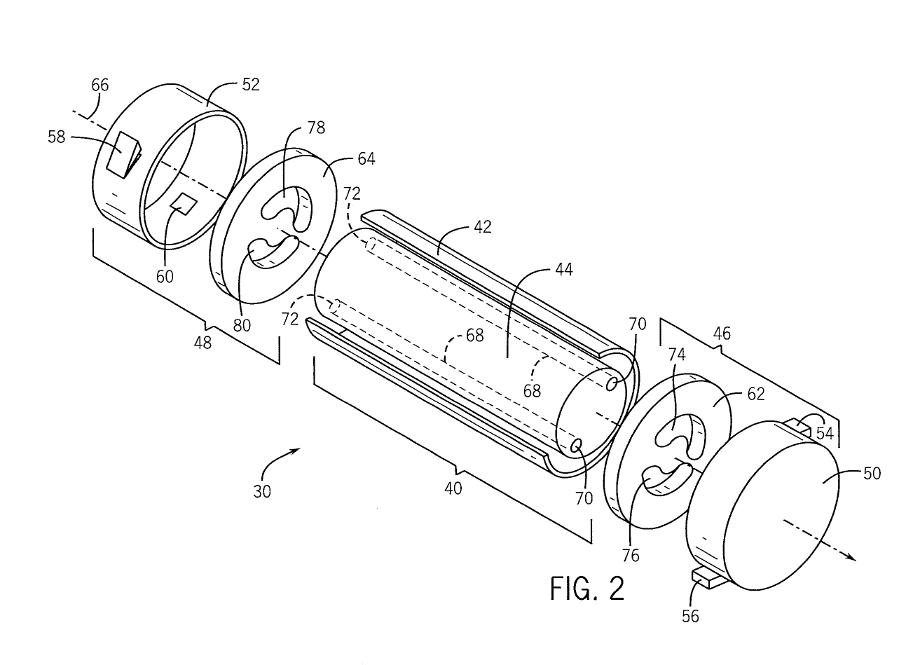

As noted above, in certain embodiments, the hydraulic energy transfer system 12 may include an IPX (e.g., a rotary IPX), which may be configured to receive the first fluid (e.g., proppant free fluid, pressure exchange fluid, motive fluid, etc.) from the one or more first fluid pumps 18 (e.g., high pressure pumps) and the second fluid (e.g., proppant containing fluid or frac fluid) from the one or more second fluid pumps 20. As used herein, the isobaric pressure exchanger (IPX) may be generally defined as a device that transfers fluid pressure between a high pressure inlet stream and a low pressure inlet stream at efficiencies in excess of approximately 50%, 60%, 70%, 80%, 90%, or greater without utilizing centrifugal technology. In this context, high pressure refers to pressures greater than the low pressure. For example, the high pressure may be 1.01 to 100, 1.05 to 50, 1.1 to 40, 1.2 to 30, 1.3 to 20, 1.4 to 10, or 1.5 to 5 times greater than the low pressure. The low pressure inlet stream of the IPX may be pressurized and exit the IPX at high pressure (e.g., at a pressure greater than that of the low pressure inlet stream), and the high pressure inlet stream may be depressurized and exit the IPX at low pressure (e.g., at a pressure less than that of the high pressure inlet stream). Additionally, the IPX may operate with the high pressure fluid directly applying a force to pressurize the low pressure fluid, with or without a fluid separator between the fluids. Examples of fluid separators that may be used with the IPX include, but are not limited to, pistons, bladders, diaphragms and the like. In certain embodiments, isobaric pressure exchangers may be rotary devices. Rotary isobaric pressure exchangers (IPXs), such as those manufactured by Energy Recovery, Inc. of San Leandro, Calif., may not have any separate valves, since the effective valving action is accomplished internal to the device via the relative motion of a rotor with respect to end covers, as described in detail below with respect to FIGS. 2-6. Rotary IPXs may be designed to operate with internal pistons to isolate fluids and transfer pressure with relatively little mixing of the inlet fluid streams. Reciprocating IPXs may include a piston moving back and forth in a cylinder for transferring pressure between the fluid streams. Any IPX or plurality of IPXs may be used in the disclosed embodiments, such as, but not limited to, rotary IPXs, reciprocating IPXs, or any combination thereof.

FIG. 2 is an exploded view of an embodiment of a rotary IPX 30. In the illustrated embodiment, the rotary IPX 30 may include a generally cylindrical body portion 40 that includes a sleeve 42 and a rotor 44. The rotary IPX 30 may also include two end structures 46 and 48 that include manifolds 50 and 52, respectively. Manifold 50 includes inlet and outlet ports 54 and 56, and manifold 52 includes inlet and outlet ports 60 and 58. For example, inlet port 54 may receive a first fluid (e.g., proppant free fluid) at a high pressure and the outlet port 56 may be used to route the first fluid a low pressure away from the rotary IPX 30. Similarly, inlet port 60 may receive a second fluid (e.g., proppant containing fluid or frac fluid) and the outlet port 58 may be used to route the second fluid at high pressure away from the rotary IPX 30. The end structures 46 and 48 include generally flat endplates 62 and 64 (e.g., endcovers), respectively, disposed within the manifolds 50 and 52, respectively, and adapted for fluid sealing contact with the rotor 44.

The rotor 44 may be cylindrical and disposed in the sleeve 42 in a concentric arrangement, and is arranged for rotation about a longitudinal axis 66 of the rotor 44. The rotor 44 may have a plurality of channels 68 extending substantially longitudinally through the rotor 44 with openings 70 and 72 at each end arranged symmetrically about the longitudinal axis 66. The openings 70 and 72 of the rotor 44 are arranged for hydraulic communication with the endplates 62 and 64, and inlet and outlet apertures 74 and 76, and 78 and 80, in such a manner that during rotation they alternately hydraulically expose fluid at high pressure and fluid at low pressure to the respective manifolds 50 and 52. The inlet and outlet ports 54, 56, 58, and 60, of the manifolds 50 and 52 form at least one pair of ports for high pressure fluid in one end element 46 or 48, and at least one pair of ports for low pressure fluid in the opposite end element, 48 or 46. The endplates 62 and 64, and inlet and outlet apertures 74 and 76, and 78 and 80 are designed with perpendicular flow cross sections in the form of arcs or segments of a circle.

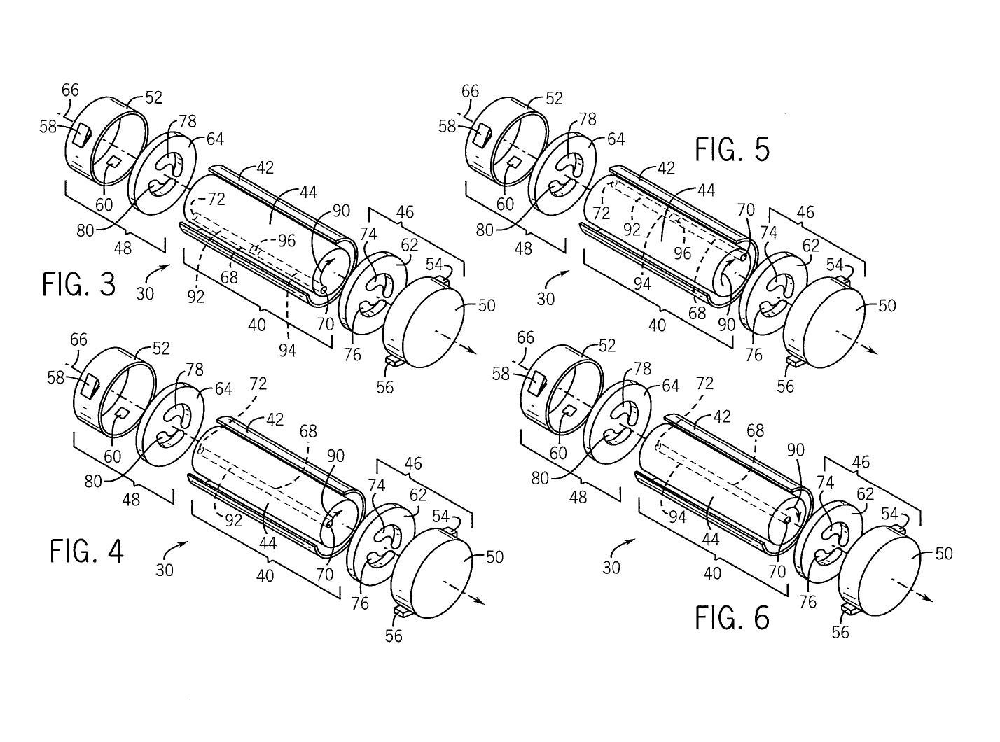

FIGS. 3-6 are exploded views of an embodiment of the rotary IPX 30 illustrating the sequence of positions of a single channel 68 in the rotor 44 as the channel 68 rotates through a complete cycle. It is noted that FIGS. 3-6 are simplifications of the rotary IPX 30 showing one channel 68, and the channel 68 is shown as having a circular cross-sectional shape. In other embodiments, the rotary IPX 30 may include a plurality of channels 68 (e.g., 2 to 100) with different cross-sectional shapes (e.g., circular, oval, square, rectangular, polygonal, etc.). Thus, FIGS. 3-6 are simplifications for purposes of illustration, and other embodiments of the rotary IPX 30 may have configurations different from that shown in FIGS. 3-6. As described in detail below, the rotary IPX 30 facilitates a hydraulic exchange of pressure between first and second fluids (e.g., proppant free fluid and proppant-laden fluid) by enabling the first and second fluids to momentarily contact each other within the rotor 44. In certain embodiments, this exchange happens at speeds that results in little mixing of the first and second fluids.

In FIG. 3, the channel opening 70 is in a first position. In the first position, the channel opening 70 is in hydraulic communication with the aperture 76 in endplate 62 and therefore with the manifold 50, while opposing channel opening 72 is in hydraulic communication with the aperture 80 in endplate 64 and by extension with the manifold 52. As will be discussed below, the rotor 44 may rotate in the clockwise direction indicated by arrow 90. In operation, low pressure second fluid 92 passes through endplate 64 and enters the channel 68, where it contacts first fluid 94 at a dynamic interface 96. The second fluid 92 then drives the first fluid 94 out of the channel 68, through the endplate 62, and out of the rotary IPX 30. However, because of the short duration of contact, there is minimal mixing between the first fluid 94 and the second fluid 92.

In FIG. 4, the channel 68 has rotated clockwise through an arc of approximately 90 degrees. In this position, the opening 72 is no longer in hydraulic communication with the apertures 78 and 80 of the endplate 64, and the opening 70 of the channel 68 is no longer in hydraulic communication with the apertures 74 and 76 of the endplate 62. Accordingly, the low pressure second fluid 92 is temporarily contained within the channel 68.

In FIG. 5, the channel 68 has rotated through approximately 180 degrees of arc from the position shown in FIG. 3. The opening 72 is now in hydraulic communication with the aperture 78 in the endplate 64, and the opening 70 of the channel 68 is now in hydraulic communication with the aperture 74 of the endplate 62. In this position, high pressure first fluid 94 enters and pressures the low pressure second fluid 94, driving the second fluid 94 out of the channel 68 and through the aperture 74 for use in the hydraulic fracturing system 10.

In FIG. 6, the channel 68 has rotated through approximately 270 degrees of arc from the position shown in FIG. 3. In this position, the opening 72 is no longer in hydraulic communication with the apertures 78 and 80 of the endplate 64, and the opening 70 is no longer in hydraulic communication with the apertures 74 and 76 of the endplate 62. Accordingly, the high pressure first fluid 94 is no longer pressurized and is temporarily contained within the channel 68 until the rotor 44 rotates another 90 degrees, starting the cycle over again.

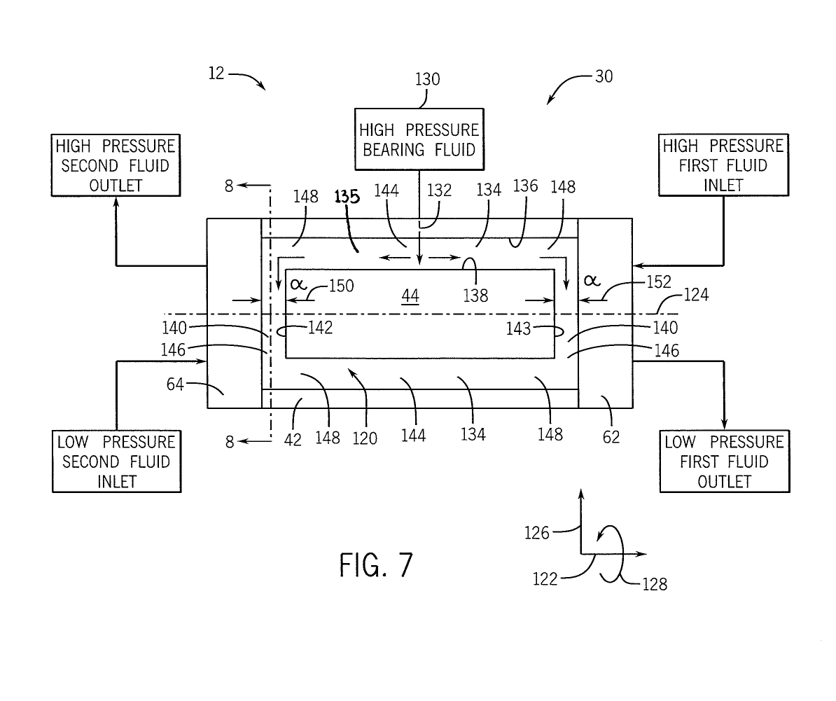

As noted above, the hydraulic energy transfer system 12 (e.g., the rotary IPX 30) may include a fluid bearing system (e.g., a hydrostatic bearing system and/or a hydrodynamic bearing system) configured to facilitate the rotation of rotating components within the hydraulic energy transfer system 12, such as the rotor 44. A hydrostatic bearing system is an externally pressurized fluid bearing. A hydrodynamic bearing system is a fluid bearing that is at least partially pressurized by the rotation of rotating components. For example, FIG. 7 is a schematic diagram of an embodiment of the hydraulic fracturing system 10 that includes the rotary IPX 30 including a fluid bearing system 120. In the following discussion, reference may be made to various directions or axes, such as an axial direction 122 along a rotational axis 124 of the rotor 44, a radial direction 126 away from the axis 124, and a circumferential direction 128 around the axis 124.

Generally, a high pressure bearing fluid 130 may be introduced in proximity to the axial midplane of the rotor 44. The high pressure bearing fluid 130 facilitates radial and axial load bearing of the rotor 44 and in particular, supports the rotor 44 on a fluid film to facilitate rotation of the rotor 44. The high pressure bearing fluid 130 may also help to purge, flush, and/or clean out any debris or particulates from the regions between the rotating components of the rotary IPX 30. The high pressure bearing fluid 130 may be any suitable fluid, such as a proppant-free fluid, a particulate-free fluid, a non-abrasive fluid, water, oil, grease, liquid/powder lubricant mixtures, or a combination thereof. In some embodiments, the high pressure bearing fluid 130 may be the high pressure first fluid from the first fluid pumps 18. Additionally, the high pressure bearing fluid 130 may be at any suitable pressure. For example, in some embodiments, the high pressure bearing fluid 130 may be at a higher pressure than the low pressure second fluid. In certain embodiments, the high pressure bearing fluid 130 may be at a pressure that is within approximately 50% and 150%, 75% and 125%, 95% and 105%, or any other suitable range, of the high pressure first fluid.

The high pressure bearing fluid 130 may pass through a bearing inlet 132 of the sleeve 42 of the rotary IPX 30 and may enter a plenum region 134 (e.g., chamber). The plenum region 134 includes a radial plenum region 135 (e.g., an annular gap, a radial gap, radial bearing region, or axially extending plenum) between an inner wall 136 (e.g., inner surface) of the sleeve 42 and an outer wall 138 (e.g., an outer radial surface or an outer lateral surface) of the rotor 44. For example, the walls 146 and 138 may be coaxial or concentric annular walls, which have annular surfaces that face one another with an intermediate annular space (e.g., radial clearance or gap circumferentially 128 about the axis 122) defining the plenum region 135. As illustrated, the outer wall 138 extends from a first axial face 142 of the rotor 44 to a second axial face 143 of the rotor 44. The first axial face 142 is disposed proximate to and interfaces with the second endplate 64, and the second axial face 143 is disposed proximate to and interfaces with the first endplate 62. In certain embodiments, the plenum region 134 may also include axial bearing regions 140 (e.g., axial gaps, axial plenum regions, or radially extending plenums) between the first and second axial faces 142 and 143 of the rotor 44 and the respective endplates 62 and 64. In some embodiments, the plenum region 134 may surround (e.g., circumscribe) the outer surfaces of the rotor 44 (e.g., the outer wall 138, the first axial face 142 and the second axial face 143). Thus, the plenum region 134 may be disposed between the outer surfaces of the rotor 44 (e.g., the outer wall 138, the first axial face 142 and the second axial face 143), the inner wall 136 of the sleeve 42, and the endplates 62 and 64. The high pressure bearing fluid 130 may circulate from a high pressure region 144 of the plenum region 134 toward the axial faces 142 of the rotor 44, then toward a lower pressure region 146 of the plenum region 134 in the radial direction 126, thereby facilitating the radial and axial load bearing of the rotor 44. Indeed, as the high pressure bearing fluid 130 circulates from the high pressure region 144 to the lower pressure region 146, it may pass through radial bearing regions 148 between the rotor 44 and the sleeve 42 and the axial bearing regions 140 between the rotor 44 and the endplates 62 and 64.

As illustrated, the rotor 44 is axially centered within the sleeve 42 wherein an axial distance 150 (e.g., clearance) between the first axial face 142 and the endplate 62 is equal to an axial distance 152 (e.g., clearance) between the second axial face 143 and the endplate 64. As will be described in more detail below, in certain embodiments, net axial forces may act on the rotor 44, which may cause the rotor 44 to translate in the axial direction 122 and thus, may alter the distance 150 and the distance 152, thereby causing one of the axial distances 150 or 152 to be greater than the other.

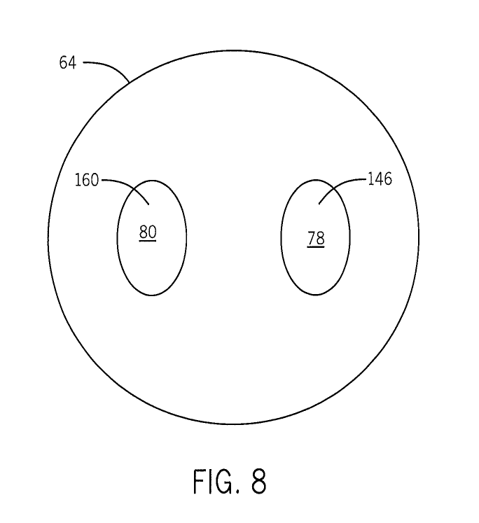

FIG. 8 is a cross-sectional view of the endplate 64 taken along line 8-8 of the rotary IPX 30 of FIG. 7. Specifically, the illustrated embodiment depicts the low pressure region 146 along the axial bearing region 140 with respect to the axial surface of the endplate 64. The low pressure region 146 includes an opening in the endplate 64 for low pressure fluid to enter (e.g., the inlet 78 for the low pressure second fluid inlet). Similarly, the low pressure region 146 of the endplate 62 includes an opening in the endplate 62 for low pressure fluid to exit (e.g., the outlet 76 for the low pressure first fluid outlet). Therefore, the region 146 is at low pressure, and the area about the region 146 is also at a lower pressure due to its hydraulic proximity (e.g., distance) to the region 146. Additionally, the endplate 64 includes a high pressure region 160, which includes an opening in the endplate 64 for high pressure fluid to exit (e.g., the outlet 80 for the high pressure second fluid outlet). Similarly, the endplate 62 includes the high pressure region 160, which includes an opening in the endplate 62 for high pressure fluid to enter (e.g., the inlet 80 for the high pressure first fluid inlet). Therefore, the region 160 is at high pressure, and the area about the region 160 is also at a higher pressure due to its hydraulic proximity to the region 160 and to the perimeter of the respective endplate (which is also generally at a higher pressure). The hydraulic proximity may be understood to be the amount of resistance there is to a flow between two points. Indeed, two points that are closer together will generally be in closer hydraulic proximity than two points that are farther apart. Further, two points that are separated by a flow path with a larger hydraulic diameter will be in closer proximity than two points that are separated by a tighter flow path (e.g., the flow path with the larger hydraulic diameter will have less resistance than the flow path with the smaller diameter).

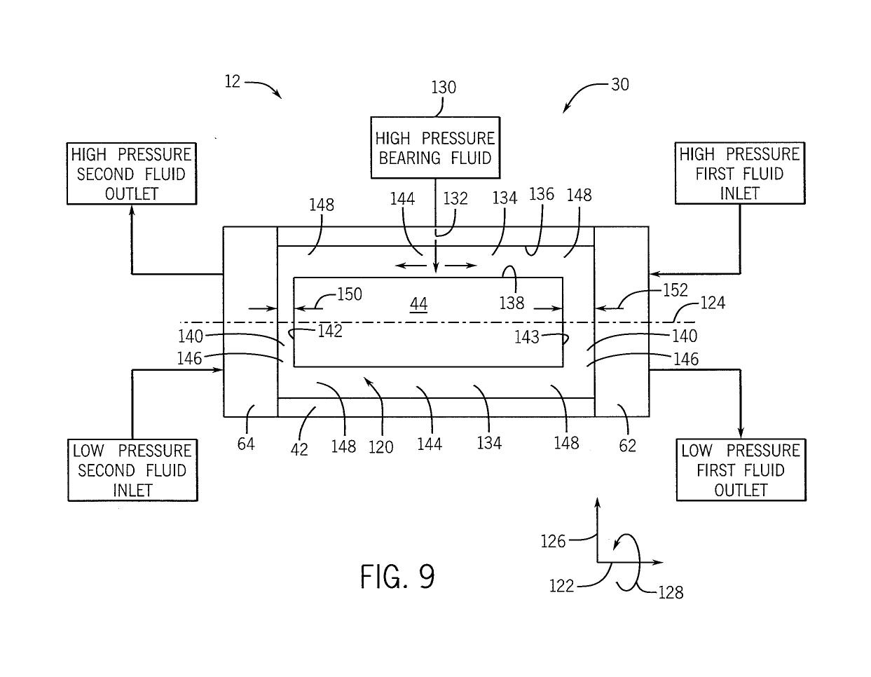

As noted above, unbalanced axial forces may act on the rotor 44 (e.g., due to axial face pressure distribution and/or magnitude differences), which may cause the rotor 44 to axially translate. In some embodiments, unbalanced axial forces on the rotor 44 may cause the rotor to axially translate toward the endplate 64. For example, FIG. 9 illustrates an embodiment of the rotary IPX 30 in which the rotor 44 has axially translated and is not axially centered (i.e., in axial direction 122) within the sleeve 42. As illustrated, the rotor 44 has translated in the axial direction 122 such that the axial gap or distance 150 is less than the axial gap or distance 152. As such, the axial bearing region 140 between the first axial face 142 and the endplate 64 has decreased in both volume and in the axial direction 122, and the axial bearing region 140 between the second axial face 143 and the endplate 62 has increased in both volume and in the axial direction 122. The increase in the axial bearing region 140 between the second axial face 143 and the endplate 62 allows the high pressure bearing fluid 130 to escape (e.g., around the circumference of the second axial face 143), thereby decreasing a net hydrostatic force acting on the second axial face 143 of the rotor 44. The decreased hydrostatic force acting on the second axial face 143 of the rotor 44 tends to decrease the distance 152 of the axial bearing region 140. Additionally, because the axial bearing region 140 between the first axial face 142 and the endplate 64 has decreased, the high pressure bearing fluid 130 in the axial bearing region 140 between the first axial face 142 and the endplate 64 increases in pressure, which results in a restoring force to resist the decrease in the distance 150. In this manner, the hydrostatic bearings work in tandem on both axial faces 142 and 143 to resist axial displacement of the rotor 44 and facilitate steady rotation of the rotor 44.

While the fluid bearing system 120 may resist axial displacement of the rotor 44, it may also be desirable to include hydrodynamic bearing features that correct for, counteract, adjusts, and/or balances the net axial forces acting on the rotor 44. For example, as noted above, in certain scenarios, net (e.g., unbalanced) axial forces acting on the rotor 44 may cause the rotor 44 to axially translate toward the endplate 64 (e.g., the low pressure second fluid inlet side). Accordingly, it may be desirable to design features of the fluid bearing system 120 that correct for, counteract, adjust, and/or balance the net axial forces on the rotor 44, which tend to axially translate the rotor 44 toward the endplate 64, to restore the rotor 44 to a neutral, centered position about the sleeve 42, as illustrated in FIG. 7.

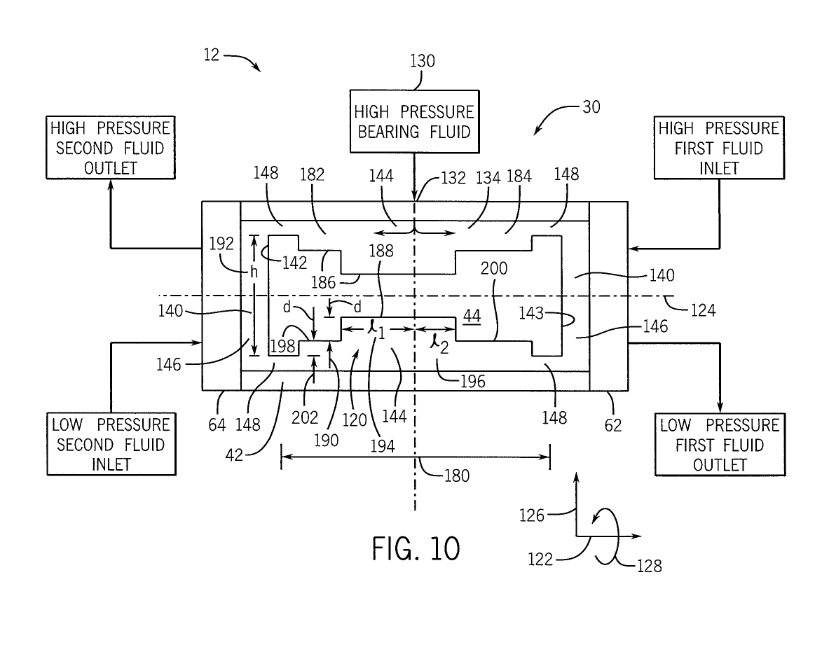

FIG. 10 illustrates an embodiment of the rotary IPX 30 including an embodiment of the fluid bearing system 120 that is configured to correct for, counteract, and/or balance the net axial forces acting on the rotor 44. For example, the plenum region 134 of the fluid bearing system 120 is asymmetric about an axial midplane 180 of the rotor 44. The axial midplane 180 is centered about a total length of the rotor 44. In particular, the plenum region 134 is asymmetric about the midplane 180 of the rotor 44, such that a first portion 182 (e.g., a first plenum region or annular chamber) of the plenum region 134 that is disposed between the midplane 180 and the endplate 64 (e.g., extends from the midplane 180 to the endplate 64) has a larger volume than a second portion 184 (e.g., a second plenum region or annular chamber) of the plenum region 134 that is disposed between the midplane 180 and the endplate 62 (e.g., extends from the midplane 180 to the endplate 62). For example, the first portion 182 may have a volume that is greater than a volume of the second portion 182 by approximately 1% to 100%, 5% to 90%, 10% to 80%, 15% to 70%, 20% to 60%, 25% to 50%, or any other suitable range. As such, the radial plenum region 135 is asymmetric about the midplane 180. In some embodiments, the bearing inlet 132 may be approximately aligned with the midplane 180 such that the bearing inlet 132 is approximately aligned with the axial center of the rotor 44. It should be appreciated that the bearing inlet 132 may be approximately aligned within a margin of error (e.g., the bearing inlet 132 may be offset by the axial center by an offset distance that is within 5% of a total length of the rotor 44). By increasing the volume of the first portion 182 relative to the volume of the second portion 184, the fluid resistance from the bearing inlet 132 to the axial bearing region 140 that is proximate to the endplate 64 may decrease relative to the fluid resistance from the bearing inlet 132 to the axial bearing region 140 that is proximate to the endplate 62. That is, the fluid resistance on (e.g., applied to) a high pressure bearing fluid path through the first portion 182 toward the endplate 64 may be less than the fluid resistance on (e.g., applied to) the high pressure bearing fluid path through the second portion 184 toward the endplate 62, thereby increasing the hydrostatic pressure in the axial bearing region 140 proximate to the endplate 64 relative to the hydrostatic pressure in the axial bearing region 140 proximate to the endplate 62. The hydrostatic pressure of the bearing fluid in the axial bearing region 140 may apply an axial force on the first axial face 142 to reduce, resist, or avoid axial translation of the rotor 44 toward the endplate 64. As such, the increased hydrostatic pressure in the axial bearing region 140 proximate to the endplate 64 may correct for, counteract, and/or offset the net axial forces acting on the rotor 44 that may cause the rotor 44 to axially translate toward the endplate 64.

As illustrated, the rotor 44 may include one or more grooves 186 (e.g., radial and/or axial recesses, notches, etc.) to create a variable width flow path for the high pressure bearing fluid 130. In some embodiments, one or more of the grooves 186 may extend 360 degrees about the rotational axis 124. In certain embodiments, one or more of the grooves 186 may extend partially about the rotational axis 124 (e.g., between approximately 1 degree and 359 degrees). Features of the grooves 186, such as the depth and/or length, may be adjusted to create the asymmetric plenum region 134. That is, the rotor 44 (e.g., the outer wall 138 of the rotor 44) and the one or more grooves 186 may be asymmetric about the axial midplane 180 to create the asymmetric plenum region 134. For example, in the illustrated embodiment, the rotor 44 includes a first groove 188 (e.g., radial and/or axial recess, notch, etc.) with a first depth 190 relative to a height 192 of the rotor 44. The first groove 188 is axially offset from the axial midplane 180, thus creating the asymmetric plenum region 134. In particular, the first groove 188 includes a first length 194 to the left of the axial midplane 180 (e.g., toward the first axial face 142 of the rotor 44) and a second length 196 to the right of the axial midplane 180 (e.g., toward the second axial face 143 of the rotor 44), and the first length 194 is greater than the second length 196. As such, the volume of the first portion 182 of the plenum region may be greater than a volume of the second portion 184 of the plenum region, thereby offsetting the net axial forces acting on the rotor 44. The first length 194 may be greater than the second length 196 by approximately 1% to 100%, 5% to 90%, 10% to 80%, 15% to 70%, 20% to 60%, 25% to 50%, or any other suitable range.

Additionally, the rotor 44 may also include a second groove 198 (e.g., radial and/or axial recess, notch, etc.) and a third groove 200 (e.g., radial and/or axial recess, notch, etc.) with a second depth 202. However, it should be appreciated that in other embodiments, the second and third grooves 198 and 200 may have different depths. For example, in certain embodiments, the second groove 198 may have a depth that is greater than a depth of the third groove 200 to further increase the volume of the first portion 182 of the plenum region 134 relative to the second region 184 of the plenum region 134. It should be appreciated that the rotor 44 may have any number of grooves 186 (e.g., 1, 2, 3, 4, 5, 6, 7, 8, or more) that may be disposed along the axial length of the rotor 44 in any suitable location. Further, the grooves 186 may be configured in a plurality of cross-sections (e.g., rectangular, semi-circular, trapezoidal, irregular, wavy, etc.). Still further, it should be appreciated that the sleeve 42 may include the grooves 186 in addition to or instead of the grooves 186 formed in the rotor 44. Additionally, it should be appreciated that the rotor 44 and/or the sleeve 42 may include protrusions in addition to or instead of the grooves 186.

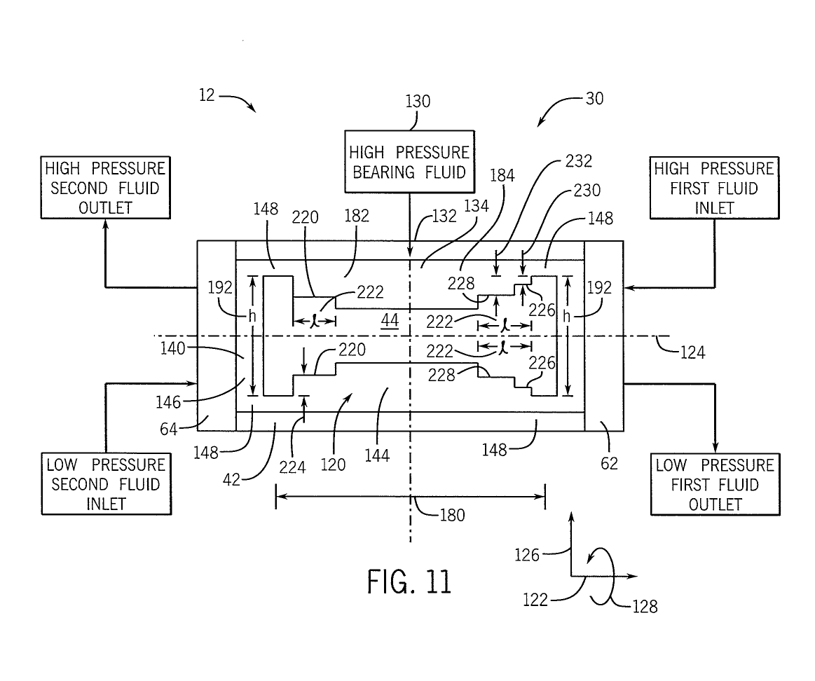

FIG. 11 illustrates an embodiment of the rotary IPX 30 including a first number of grooves between the axial midplane 180 and the endplate 64 and a second number of grooves between the axial midplane 180 and the endplate 62 to create the asymmetric plenum region 134 (e.g., asymmetric annular region). As illustrated, the axial faces of the rotor 44 may have the same height 192 (e.g., radial dimension or diameter), such that the axial faces are the same size and geometry. This may facilitate radial bearings of the rotor 44 and the balancing of the rotor 44. The rotor 44 may also include a first groove 220 (e.g., radial and/or axial recess, notch, etc.) disposed between the axial midplane 180 and the endplate 64. The first groove 220 has a first length 222 and a first depth 224 relative to the height 192 (e.g., radial dimension or diameter) of the rotor 44. The rotor 44 also includes a second groove 226 (e.g., radial and/or axial recess, notch, etc.) and a third groove 228 (e.g., radial and/or axial recess, notch, etc.) disposed between the axial midplane 180 and the endplate 62. As illustrated, the combined length of the second and third grooves 226 and 228 is the same as the length 222 of the first groove 220. However, it should be appreciated that the lengths may vary. Indeed, as noted above, the dimensions of the grooves may be the same or different. For example, a second depth 230 of the second groove 226 and a third depth 232 of the third groove 228 (relative to the height 192 of the rotor 44) are different than the first depth 224 of the first groove 220. As such, the second and third grooves 226 and 228 decrease the volume of the second portion 184 of the plenum region 134 relative to the first portion 182. As noted above, this may increase the bearing pressure in the axial bearing region 140 proximate to the endplate 64 relative to the bearing pressure in the axial bearing region 142 proximate to the endplate 62, thereby compensating for, correcting, and/or offsetting the axial forces on the rotor 44 that cause the rotor 44 to translate in the axial direction 126 toward the endplate 64.

It should be appreciated that the fluid bearing system 120 may include any features that create a bias between the flow resistance toward the endplate 64 and the flow resistance of the high pressure bearing fluid 130 toward the plate 62, and in particular, that decrease the flow resistance toward the endplate 64 relative to the flow resistance of the high pressure bearing fluid 130 toward the endplate 62. For example, other embodiments may include offsetting the inlet 132 of the high pressure bearing fluid 130 relative to the axial midplane 180 of the rotor 44 such that the inlet 132 is closer to the endplate 64 than the endplate 62. That is, the inlet 132 may be offset from the axial midplane 180 such that a first distance between the inlet 132 and the endplate 64 is less than a second distance between the inlet 132 and the endplate 62. In other embodiments, two or more inlets 132 for the high pressure bearing fluid 130 may be utilized, which may be independently adjustable. Further, in certain embodiments, the rotor 44 may include one or more adjustable features (e.g., adjustable pistons) disposed on and/or integral with the outer wall 138 of the rotor 44 that are adjustable in size and/or dimensions to adjust the volume of the plenum region 134.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a rotary isobaric pressure exchanger (IPX) configured to exchange pressures between a first fluid and a second fluid, wherein the rotary IPX comprises:
a sleeve;
a rotor disposed within the sleeve in a concentric arrangement;
a first endplate disposed proximate to a first axial face of the rotor;
a second endplate disposed proximate to a second axial face of the rotor; and
a plenum comprising a radial gap between an outer lateral surface of the rotor and an inner surface of the sleeve, a first axial gap between the first axial face of the rotor and the first endplate, and a second axial gap between the second axial face of the rotor and the second endplate, wherein the plenum is asymmetric about an axial midplane of the rotor; and
a hydrostatic bearing system configured to route a bearing fluid to the plenum.

2. The system of claim 1, wherein the plenum comprises a first portion extending from the axial midplane to the first endplate and a second portion extending from the axial midplane to the second endplate, wherein a first volume of the first portion is less than a second volume of the second portion.

3. The system of claim 2, wherein the bearing fluid is configured to apply an axial force against the second axial face to resist axial displacement of the rotor toward the second endplate.

4. The system of claim 3, wherein the first endplate comprises a high pressure first fluid inlet and a low pressure first fluid outlet, and the second endplate comprises a low pressure second fluid inlet and a high pressure second fluid outlet.

5. The system of claim 3, wherein the rotary IPX comprises a bearing fluid inlet through the sleeve, the bearing fluid inlet is approximately aligned with the axial midplane and is configured to receive the bearing fluid from the hydrostatic bearing system, and a first fluid resistance from the bearing fluid inlet to the second endplate is less than a second fluid resistance from the bearing fluid inlet to the first endplate.

6. The system of claim 1, wherein the outer lateral surface of the rotor comprises one or more grooves.

7. The system of claim 6, wherein the one or more grooves comprises a first groove formed in the outer lateral surface between the axial midplane and the second axial face.

8. The system of claim 7, wherein the one or more grooves comprises a second groove formed in the outer lateral surface between the axial midplane and the first axial face, and wherein a first depth of the first groove is greater than a second depth of the second groove, a first length of the first groove is greater than a second length of the second groove, or both.

9. A system, comprising:
a rotary isobaric pressure exchanger (IPX) configured to exchange pressures between a first fluid and a second fluid, wherein the rotary IPX comprises:
a sleeve comprising a bearing inlet;
a rotor disposed within the sleeve in a concentric arrangement, wherein the rotor comprises a first axial end face, a second axial end face disposed opposite the first axial end face, and an outer later surface extending from the first axial face to the second axial face;
a first endplate disposed proximate to the first axial end face;
a second endplate disposed proximate to the second axial end face; and
a plenum comprising a radial gap disposed between the outer later surface of the rotor and an inner surface of the sleeve, a first axial gap disposed between the first axial end face and the first endplate, and a second axial gap disposed between the second axial end face and the second endplate, wherein the plenum is asymmetric about an axial midplane of the rotor; and
a hydrostatic bearing system configured to route a bearing fluid through the bearing inlet to the plenum, wherein the bearing fluid has a higher pressure than the second fluid at low pressure.

10. The system of claim 9, wherein a first volume of the plenum that extends from the axial midplane to the first endplate is less than a second volume of the plenum that extends from the axial midplane to the second endplate.

11. The system of claim 10, wherein a first fluid resistance from the bearing inlet to the second endplate is less than a second fluid resistance from the bearing inlet to the first endplate.

12. The system of claim 11, wherein the bearing inlet is approximately aligned with the axial midplane of the rotor.

13. The system of claim 11, wherein the hydrostatic bearing system is configured to resist axial displacement of the rotor toward the second endplate.

14. The system of claim 13, wherein the first endplate comprises a first inlet configured to receive the first fluid at high pressure and a first outlet configured to output the first fluid at low pressure, and the second endplate comprises a second inlet configured to receive the second fluid at low pressure and a second outlet configured to output the second fluid at high pressure.

15. The system of claim 9, wherein the outer lateral surface of the rotor comprises one or more grooves, and the outer lateral surface is asymmetric about the axial midplane of the rotor.

16. A system, comprising:
a rotary isobaric pressure exchanger (IPX) configured to exchange pressures between a first fluid and a second fluid, and the rotary IPX comprises:
a sleeve comprising a bearing inlet;
a rotor disposed within the sleeve in a concentric arrangement, wherein the rotor comprises a first axial end face, a second axial end face disposed opposite the first axial end face, and an outer later surface extending from the first axial face to the second axial face;
a first endplate disposed proximate to the first axial end face;
a second endplate disposed proximate to the second axial end face; and
a plenum comprising a radial gap disposed between the outer later surface of the rotor and an inner surface of the sleeve, a first axial gap disposed between the first axial end face and the first endplate, and a second axial gap disposed between the second axial end face and the second endplate; and
a hydrostatic bearing system configured to route a bearing fluid through the bearing inlet to the plenum, wherein the bearing fluid has a higher pressure than the second fluid at low pressure, and a first fluid resistance on the bearing fluid from the bearing inlet to the first axial gap is greater than a second fluid resistance on the bearing fluid from the inlet to the second axial gap.

17. The system of claim 16, wherein the plenum is asymmetric about an axial midplane of the rotor, and a first volume of the plenum that extends from the axial midplane to the first endplate is less than a second volume of the plenum that extends from the axial midplane to the second endplate.

18. The system of claim 17, wherein the bearing inlet is approximately aligned with the axial midplane.

19. The system of claim 16, wherein the bearing inlet is offset from an axial midplane of the rotor, and a first distance between the bearing inlet and the first endplate is greater than a second distance between the bearing inlet and the second endplate.

20. The system of claim 16, wherein the first endplate comprises a first inlet configured to receive the first fluid at high pressure and a first outlet configured to output the first fluid at low pressure, and the second endplate comprises a second inlet configured to receive the second fluid at low pressure and a second outlet configured to output the second fluid at high pressure.
